(19) United States
(12) Patent Application Publication
(10) Pub. No.: US 2007/0148548 A1
(43) Pub. Date: Jun. 28, 2007

(54) Non-aqueous electrolytic secondary battery

(75) Inventors: Takashi Suzuki, Aichi (JP); Toshiyuki Miwa, Shizuoka (JP); Hiroto Sagisaka, Shizuoka (JP); Yusuke Tamura, Shizuoka (JP); Kazuo Takada, Shizuoka (JP); Yasuo Suzuki, Aichi (JP)

Correspondence Address: HARNESS, DICKEY & PIERCE, P.L.C., P.O. BOX 828, BLOOMFIELD HILLS, MI, 48303, US

(73) Assignee: FDK CORPORATION, Tokyo (JP)

(21) Appl. No.: 11/649,322

(22) Filed: Jan. 2, 2007

Related U.S. Application Data
(63) Continuation of application No. PCT/JP05/11720, filed on Jun. 27, 2005.

(30) Foreign Application Priority Data
Jul. 2, 2004 (JP) 2004-196790

(51) Int. Cl. H01M 4/58

(52) U.S. Cl. 429/231.8; 429/231.95

(57) ABSTRACT

A non-aqueous electrolyte secondary battery includes a positive electrode 11 made of graphite powder and a negative electrode 13 made of lithium metal or a lithium-intercalatable/deintercalatable material. The positive electrode 11 and the negative electrode 13 are faced to each other with an electrolyte, containing a lithium salt, interposed in between. The positive electrode 11 has a carbon-derived absorption peak which appears within a range of 3200 gauss to 3400 gauss in an electron spin resonance method in which measurement is performed using an X band. A relative ratio (ΔH_{40K}/ΔH_{296K}) of the full width of half maximum intensity ΔH_{40K} of the peak measured at a temperature of 40 K to the full width of half maximum intensity ΔH_{296K} of the peak measured at a temperature of 296 K is 2.1 or more. Accordingly, it is possible to provide the non-aqueous electrolyte secondary battery which prevents degradation of the capacity in charge/discharge cycles after performing high temperature floating charge.

### TECHNICAL FIELD

The present invention relates to a non-aqueous electrolyte secondary battery, and in particular to the non-aqueous electrolyte secondary battery in which: a graphite material is used as a positive electrode; lithium metal, alloy thereof, or a lithium-intercalatable/deintercalatable material is used as a negative electrode; and a non-aqueous electrolyte containing a lithium salt is used as an electrolyte.

### PRIOR ART

Various kinds of non-aqueous electrolytic secondary batteries have so far been utilized in various kinds of applications because of their high storable energy densities. The secondary batteries have a disadvantage of getting into a situation where they are difficult to continuously use, or where they cannot be used, when they complete a limited charge/discharge cycle.

From the viewpoint of improving the charge/discharge cycle life of these kinds of secondary batteries, the present inventors have focused attention on a non-aqueous electrolyte secondary battery including a positive electrode made of a graphitized carbon material, an electrolyte containing a lithium salt, and a negative electrode made of lithium metal or a lithium-intercalatable/deintercalatable material.

As described above, the non-aqueous electrolyte secondary battery including the positive electrode made of the graphitized carbon material, the electrolyte containing the lithium salt, and the negative electrode made of the lithium metal has been known from long ago. An attempt to improve the long service life of the charge/discharge cycle has been made by applying a lithium-intercalatable/deintercalatable carbon material to the negative electrode of the battery (refer to, for example, Patent Documents 1 and 2). This is because the cycle life is short as a result of the following process. The lithium metal repeats dissolution and deposition depending on the charge/discharge cycle, forms dendrite (dendritic deposition) and passivates it on the electrode.

The non-aqueous electrolyte secondary battery having the above configuration is usually assembled with no current charged. It cannot be in a dischargeable state, unless a current is charged. A charge/discharge reaction will be described below, taking an example of a case where a graphite material capable of reversibly intercalating and deintercalating lithium is used as a negative electrode.

Firstly, when a first cycle of charging is performed, anions and cations (lithium ion) in the electrolyte are intercalated into the positive electrode (the graphite material) and negative electrode, respectively. An acceptor type graphite intercalation compound and a donor type graphite intercalation compound are formed in the positive electrode and in the negative electrode, respectively. Subsequently, when the discharging is performed, the cations and anions intercalated into the respective electrodes are deintercalated, and the battery voltage is reduced. The charge/discharge reaction can be expressed by the following chemical equations.
Anode: (discharge) Cx+A⁻=CxA+e⁻ (charge)
Cathode: (discharge) Cy+Li+e⁻=LiCy (charge)

Specifically, in the positive electrode of this type of secondary battery, a reaction in which the graphite intercalation compounds are reversibly formed during the charge/discharge is utilized.

As such a positive electrode material, discussed are, for example, a graphitized carbon fiber (refer to Patent Document 3), an expanded graphite sheet (Patent Document 4), a woven cloth of graphitized carbon fiber (Patent Document 5), plastic-reinforced graphite (Non-patent Document 1), natural graphite powder (Non-patent Document 2), pyrolytic graphite (Non-patent Document 3), graphitized vapor grown carbon fiber and PAN-based carbon fiber (Non-patent Document 4).

Patent Document 1: Japanese Unexamined Patent Application Publication No. Sho 61-7567

Patent Document 2: Japanese Unexamined Patent Application Publication No. Hei 2-82466

Patent Document 3: Japanese Unexamined Patent Application Publication No. Sho 61-10882

Patent Document 4: Japanese Unexamined Patent Application Publication No. Sho 63-194319

Patent Document 5: Japanese Unexamined Patent Application Publication No. Hei 4-366554

Non-patent Document 1: John S. Dunning, William H. Tiedemann, Limin Hsueh, and Douglas N. Bennion, J. Electrochem. Soc., 118, 1886 (1971)

Non-patent Document 2: Yoshiyuki Takada, and Yoshizou Miyake, Electrochemical, 43, 329 (1975)

Non-patent Document 3: T. Ohzuku, Z. Takehara and S. Yoshizawa, DENKI KAGAKU, 46, 438 (1978)

Non-patent Document 4: Morinobu Endoh, Hidetoshi Nakamura, Akihiko Emori, Satoshi Ishida, and Michio Inagaki, Carbon, 150, 319 (1991)

### DISCLOSURE OF THE INVENTION

This type of battery generally has a disadvantage that the discharge capacity thereof is degraded successively during charge and discharge progressed. This is mainly caused by the degradation of the positive electrode material. Specifically, with repetition of charge/discharge cycles, anions each having a relatively large molecular size are repeatedly intercalated into/deintercalated from a graphite material thereof. Thereby, the graphite crystal is broken down, and cracks are created on particles thereof. As a result, a part of the positive electrode material is changed in a form which does not allow charge/discharge cycles.

To solve the above problem, the present inventors proposed, for example, a boronated graphite material (International Patent Application No. PCT/JPO/04705) formed by substituting the part of carbon atoms which constructs the hexagonal net planes of the graphite crystal with boron atoms, as well as graphite powder (International Patent Application No. PCT/JP03/12906) graphitized in the following fashion. Specifically, it is graphitized by pulverizing a graphitizing carbon material or pulverizing one or more kinds of materials selected from a group consisting of a starting raw material thereof and a carbon precursor so as to have a particle size average of 50 pm or less, and thereafter by heat-treating the same at 1700° C. or more in an inert gas atmosphere. By using these graphite materials as the positive electrode, it has become possible to suppress the degradation of the capacity, which is caused by repeated charge/discharge cycle to a large extent.

In a case where this type of secondary battery is utilized as an uninterruptible power supply or the power source for various kinds of memory backups, the charge/discharge is performed in such a cycle that the battery is continuously charged at a predetermined voltage, and discharged as necessary. This charging method, referred to as “floating charge,” is extremely common as a method of charging a battery.

The ambient temperature around the battery is varied corresponding to applications during performing the floating charge, but is often increased to room temperature or more due to the heat generated by a charging circuit. This is because the charging circuit is also continuously held in an operative state in the following process. During the floating charge, a predetermined voltage is continuously applied to the battery so that current, even though extremely minute amounts, is continuously flowed.

Thus, the secondary battery used in this type of application is required to be so reliable that, for example, battery characteristics are less degraded even if it is continuously charged generally at about 60° C., and that the appearance thereof is not changed in forms of a leak of liquid electrolyte, rupture and the like. However, the lithium secondary battery (non-aqueous electrolyte secondary battery) proposed by the present inventors has a problem that the charge/discharge capacity thereof is reduced when the floating charge is performed at a high ambient temperature of 60° C. or more.

The present invention is intended to improve the reliability of the battery with respect to the high temperature floating charge. It is an object of the present invention to provide a non-aqueous electrolyte secondary battery which has a suppressed degradation of the capacity even in the charge/discharge cycle after the high temperature floating charge.

The objects and configurations other than those described above will be apparent from the description and accompanying drawings in the present specification.

### MEANS FOR SOLVING PROBLEMS

To achieve the above object, the present invention discloses the following means.

Specifically, the present invention relates to a non-aqueous electrolyte secondary battery in which a positive electrode made of graphite powder, and a negative electrode made of lithium metal or a lithium-intercalatable/deintercalatable material are faced to each other with an electrolyte, containing a lithium salt, interposed in between. The non-aqueous electrolyte secondary battery is characterized in that the positive electrode has a carbon-derived absorption peak that appears within a range of 3200 gauss to 3400 gauss in an electron spin resonance method in which measurement is performed using an X band, and that a relative ratio (ΔH₄₀ₖ/ΔH_{296K}) of the full width of half maximum intensity ΔH_{40K} of the peak measured at a temperature of 40 K to the full width of half maximum intensity ΔH_{296K} of the peak measured at a temperature of 296 K of the positive electrode is 2.1 or more.

### BRIEF DESCRIPTION OF THE DRAWINGS

FIG. 1 is a characteristic graph showing a primary differential ESR spectrum of graphite powder at 296 K.

FIG. 2 is a characteristic graph showing the ESR absorption spectrum of the graphite powder at 296 K.

FIG. 3 is a cross-sectional view of a non-aqueous electrolyte secondary battery fabricated as an example of the present invention.

FIG. 4 is a characteristic graph showing the temperature dependence of the absorption intensity (absorption intensity measured by the ESR method) in each graphite powder (A to F) FIG. 5 is a characteristic graph showing the temperature dependence of the full width of half maximum intensity of each graphite powder (A to F) FIG. 6 is a characteristic graph showing a relationship between the relative ratio (ΔH_{40K}/ΔH_{296K}) of the positive electrode graphite powder and the ratio of residual capacity measured after high temperature floating charge.

### BEST MODES FOR CARRYING OUT THE INVENTION

Firstly, the following description is made about the theoretical background of the present invention.

A lithium battery to which the present invention is applied, as described above, is a non-aqueous electrolyte secondary battery in which a positive electrode made of graphite powder, and a negative electrode made of lithium metal or a lithium-intercalatable/deintercalatable material are faced to each other with an electrolyte, containing a lithium salt, interposed in between. The non-aqueous electrolyte secondary battery is characterized in that the positive electrode has a carbon-derived absorption peak that appears within a range of 3200 gauss to 3400 gauss in an electron spin resonance method using an X band, and that a relative ratio (ΔH_{40K}/ΔH_{296K}) of the full width of half maximum intensity ΔH₄₀K of the peak measured at a temperature of 40 K to the full width of half maximum intensity ΔH_{296K} of the peak measured at a temperature of 296 K is 2.1 or more.

In this respect, electron spin resonance (hereinafter abbreviated as “ESR”) is a phenomenon as follows. In the phenomenon, when a material containing unpaired electrons are placed in a static magnetic field, the energy levels of the unpaired electrons are split (Zeeman splitting), resulting in absorption of an electromagnetic ray having an energy equivalent to the difference between both split energy levels in a case where the electromagnetic ray, , is irradiated.

A measurement method using the above property for investigating the existence of unpaired electrons is called an electron spin resonance method (hereinafter abbreviated as “ESR method”). An unpaired electron is an electron solely occupying an electron orbital which is usually occupied by two electrons or an electron solely occupying a molecular orbital. Unpaired electrons contained in graphite are roughly classified into a conduction electron and a localized electron.

The conduction electron is a carrier in charge of electron conduction in the graphite, and can freely move in a hexagonal net plane. On the other hand, the localized electron exists in a dangling bond or a lattice defect on the surfaces of the particles which are introduced through a pulverization process during the synthesis of graphite powder. The localized electron also exists in an amorphous area (unorganized carbon area) of a crystallite, or on the edge of the crystallite, and does not have such a property as a carrier like the conduction electron does.

The ESR spectrum absorption intensity of the graphite powder can usually be considered to be almost constant, while a slight change thereof is noted even if the temperature of the graphite powder is decreased from room temperature to about 40 K. However, the ESR spectrum absorption intensity is rapidly increased within an extremely low temperature range of 20 K or less as the temperature is reduced. The full width of half maximum intensity of the absorption spectrum is increased with decrease in temperature, but is reversed at a temperature of approximately 40 K. The full width of half maximum intensity is rapidly decreased at a temperature lower than 40 K.

It can be seen that the spin, which provides the ESR within the temperature range from room temperature to 40 K as described above, is the spin of the conduction electron of the graphite from the fact that the temperature dependence is not found in the ESR spectrum absorption intensity within the temperature range, and that the full width of half maximum intensity of the absorption spectrum is increased with the decrease in temperature.

Because the graphite is an anisotropic crystal, the resonance magnetic field of the conduction electron is determined by the angle of a c axis direction of the crystallite to the magnetic field. The absorption intensity is the highest in a case where the magnetic field is perpendicular to the c axis. Thus, the resonance magnetic field is on a high magnetic field side. Thus, there is little change in the resonance magnetic field with decrease in temperature. In contrast, when the magnetic field is parallel to the c axis, the absorption intensity is the lowest. The resonance magnetic field is then on a low magnetic field side, and is further shifted to the lower magnetic field side when the temperature is decreased.

The graphite powder is present at various angles to the magnetic field in the test tube of the ESR measurement equipment. The absorption spectrum thereof is accordingly a combined spectrum of absorption spectrums which are generated depending on the angle of the magnetic field to the c axis of the crystallite.

The full width of half maximum intensity of the absorption spectrum caused by the conduction electron spin is increased with the decrease in temperature, but the absorption intensity shows little change.

In contrast, the ESR spectrum of the graphite within the extremely low temperature range of 20 K or less has an increase in an absorption intensity with decrease in temperature, and the full width of half maximum intensity of the absorption spectrum is reduced. The reason why the absorption intensity is increased within the extremely low temperature range of 20 K or less is that the contribution of the localized electron spin signal associated with the dangling bond and lattice defect introduced during pulverization is increased.

Since Pauli paramagnetism generated by the conduction electrons is approximately proportional to a carrier density, the contribution thereof becomes smaller at the low temperature. On the other hand, localized spins conforming to Curie rule are rapidly increased in inverse proportion to temperature T. Thus, almost only the signal generated by localized spins is observed within the extremely low temperature range of 20 K or less.

As described above, the contribution of the localized electrons to the absorption intensity of the graphite powder is increased with decrease in temperature within the extremely low temperature range of 20 K or less. However, the temperature at which the contribution starts to emerge is varied depending on the number of the localized electrons. Specifically, the larger the number of the localized electrons which exist, the higher temperature side “the temperature at which the contribution starts to emerge” is shifted to. A method of grasping the emerging of the contribution of the localized electrons with the highest sensitivity may be to focus attention on the full width of half maximum intensity ΔH₄₀ₖ of the absorption spectrum measured at 40 K.

As described above, most of the ESR absorption spectrum of the graphite powder obtained at room temperature is caused by the conduction electrons. Even if the temperature is reduced to about 40 K, there is no change in the absorption intensity thereof. The full width of half maximum intensity of the absorption spectrum at 40 K should be increased as compared to that at room temperature. However, when the contribution of the localized electrons has already emerged even at 40 K, the full width of half maximum intensity is reduced depending on the magnitude of the contribution.

On the other hand, the absorption spectrum around room temperature receives little contribution of the localized electrons. Thus, using the full width of half maximum intensity thereof as a reference, it is estimated that the larger the ratio of the full width of half maximum intensity at 40 K to that used as the reference, the lower the ratio of the number of the localized electrons to the number of the conduction electrons. In contrast, the smaller the above ratio, the larger the ratio of the number of the localized electrons to the number of the conduction electrons. As a result, in this case, the absorption spectrum tends to be easily susceptible to the localized electrons. This makes it possible to estimate that the full width of half maximum intensity is reduced at 40 K.

Thus, the relative ratio (ΔH_{40K}/H_{296K}) specified in the invention related to the present application can be considered to be an index which makes it possible to quantitatively grasp the relative ratio of the number of the conduction electrons to the number of localized electrons.

As described above, there was a problem that the charge/discharge capacity of this kind of lithium secondary battery is reduced if performing the floating charge at high temperatures of 60° C. or more. As a result of examining the cause, the following facts were found. The decomposition reaction of the electrolyte by electrochemical oxidation was promoted particularly on the surface of the graphite powder, which was the material for the positive electrode, and decomposition reaction products were accumulated on the surface of the positive electrode and the accumulated products interfered with charge/discharge reaction.

The present inventors found that there was a correlation between the reaction rate of this decomposition reaction by electrochemical oxidation and the number ratio of the conduction electrons to the localized electrons both of which existed in the graphite powder. This finding led to the completion of the present invention. Moreover, the present inventors found the following method as a method of evaluating the number ratio of the conduction electrons to the localized electrons both of which existed in the graphite powder.

Specifically, it was found that the number ratio of the conduction electrons to the localized electrons, both of which existed in the graphite powder, were able to be evaluated using the relative ratio (ΔH_{40K}/ΔH_{296K}) of the full width of half maximum intensity ΔH_{40K} of the absorption spectrum measured at a temperature of 40 K to the full width of half maximum intensity ΔH_{296K} of the absorption spectrum measured at a temperature of 296 K in the electron spin resonance method in which measurement was performed using an X band. Moreover, it was found that the degradation of the capacity due to the floating charge was inhibited if the relative ratio was 2.1 or more.

The battery using the graphite powder, which has a high ratio of the number of the localized electrons to the number of the conduction electrons, as a positive electrode material catalytically promotes the oxidative decomposition reaction of the liquid electrolyte on the surface of the graphite positive electrode when performing floating charge at 60° C. or more. Only in a case where the number of the localized electrons is constrained relative to the number of the conduction electrons, the reactivity between the localized electron and the liquid electrolyte is reduced so that the oxidative decomposition reaction of the liquid electrolyte is inhibited even if the floating charge is performed at 60° C. or more. As a result, an amount of generated gas is reduced to a large extent.

In the present invention (claim 1), the above relative ratio of the number of the conduction electrons to the number of the localized electrons is designated as the relative ratio (ΔH_{40K}/ΔH_{296K}) of the full width of half maximum intensity ΔH_{40K}of the peak measured at a temperature of 40 K to the full width of half maximum intensity ΔH_{296K} of the peak measured at a temperature of 296 K. It is specified that the range of the ratio be 2.1 or more. The lithium secondary battery using the graphite powder, which has a relative ratio (ΔH_{40K}/ΔH_{296K}described above) of less than 2.1, as a positive electrode is not preferable because the charge/discharge capacity is degraded to a large extent when performing the floating charge at high temperatures.

The number ratio of the conduction electrons to the localized electrons which exist in the graphite powder can be calculated from the ESR spectrum. However, an actual ESR measurement is commonly performed by externally applying microwave (for example, frequency X band described in claim 1) to determine an absorption curve while sweeping the magnetic field.

The spectrum obtained at this time is of a primary differential curve of absorption intensity to the magnetic field. For this reason, a spectrum data is read using a digitizer or the like, and then the data obtained can be once integrated to a magnetic field H to redepict the absorption spectrum.

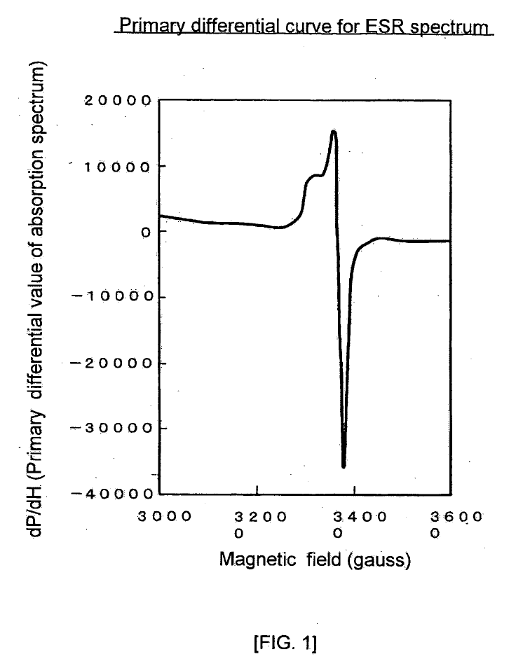

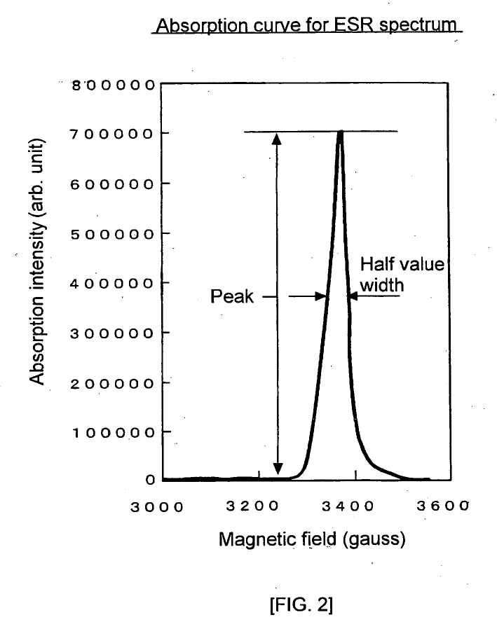

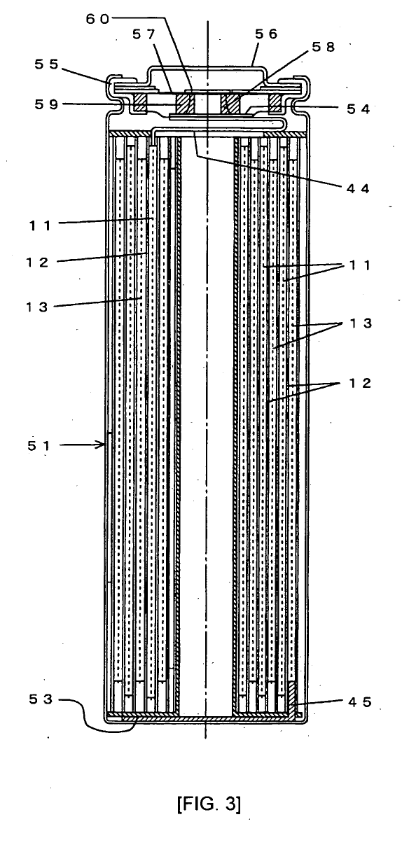

FIG. 1 shows the ESR spectrum of the graphite powder at 296 K. FIG. 2 shows an absorption spectrum obtained by integrating the ESR spectrum to the magnetic field H once. The width of the graphic at a half height of the graphic from the background can be seen as the full width of half maximum intensity of the absorption spectrum by the unit of the magnetic field (gauss) as shown in the absorption spectrum of FIG. 2.

A suitable method of synthesizing the graphite powder which meets physical property values described above in detail includes (1) a method in which the pulverized and particle size-controlled graphite powder is heat-treated, and (2) a method in which the graphite powder is surface-treated. In both methods, the graphite powder is used as a starting raw material. The lower the density of the localized electrons existing in the graphite powder, the lower the density of the post-treatment localized electrons. Thus, it is preferable that the graphite powder as a starting raw material have as small an amount of dangling bonds and lattice defects as possible.

From the above point of view, it is more preferable that the degree of the crystallization of the graphite powder as a starting raw material be higher, or, that the size of the crystallite be larger. As described above, the localized electrons exist in the lattice defect of the crystallite or the amorphous carbon area (unorganized carbon area), and the edge of the crystallite. Thus, the more complete the crystal, that is, the larger the size of the crystallite, the smaller the number of the lattice defect and the amorphous area, and the smaller the edge area of the crystallite.

At least 100 Å or more, preferably 200 Å or more, more preferably 300 Å or more of the size Lc (112) of crystallite in a c axial direction calculated from a (112) diffraction line measured by a powder X-ray diffractometry is suitable as the size of the crystallite of the graphite powder used as a starting raw material. A method of calculating the size of the crystallite by the X-ray diffractometry is as described in Non-patent Document 5 and the like.

Firstly, the first synthesis method will be described below. A usual graphite powder is obtained by graphitizing an graphitizing carbon material at 2800° C. or more to pulverize the same, or by pulverizing an graphitizing carbon material to graphitize the same. The graphite powder obtained by purifying natural graphite yielded in nature to a purity level of at least 99% or more as a fixed carbon component and pulverizing the same is also applicable. Any of usual pulverizers including a pin mill, a ball mill, and colloidal mill is applicable as the methods for pulverization.

The graphite powder specified by the present invention can be synthesized by heat-treating the graphite powder synthesized in the above manner at 1000° C. or more in a hydrogen atmosphere or a reduced-pressure atmosphere, after controlling the particle size of the same as necessary. The heat treatment can be performed in a nitrogen, helium, or argon atmosphere. However, the heat treatment in these atmospheres reduces the number of the conduction electrons so that the number ratio of the localized electrons can be relatively increased. Thus, the degradation of the capacity cannot be inhibited after the high temperature floating charge.

Then, a second synthesis method will be described below. The above described surface treatment is a method in which a functional group containing oxygen is temporarily introduced in the surfaces of particles of the graphite powder by oxidation treatment method, and subsequently deoxidation treatment is performed by heat treatment in an inert gas atmosphere. The inert gas is one which does not directly react with carbon atoms constructing a graphite crystal. Examples of the inert gas include nitrogen, helium, and argon gasses.

The oxidation treatment method for introducing a functional group containing oxygen on the surfaces of the graphite particles includes (1) a method in which the graphite powder is heat-treated at 500° C. to 800° C. in an oxygen gas atmosphere or in an oxygen-containing inert gas atmosphere, (2) a method in which the graphite powder is heat-treated at a maximum reached temperature of 500° C. to 1200° C. in an inert gas atmosphere, and in which steam is blown therein after reaching the maximum reached temperature, and (3) a method in which the graphite powder is mixed with a hydroxide of an alkali metal, and in which the graphite powder is heat-treated at 500° C. to 2000° C. Any of the above methods is used to introduce a functional group containing oxygen to the surfaces of the particles of the graphite powder. Part of the carbon atoms constructing the surface can be released, as a carbon monoxide or carbon dioxide gas, out of the system.

By performing heat treatment at 800° C. or more in an inert gas atmosphere after performing the above oxidation treatment, deoxidation is promoted to obtain the graphite powder which meets the conditions described in claim 1 of the present application. The heat treatment temperature may be arbitrarily set so that the content ratio of oxygen contained in the resultant product can be 0.001% or less by weight, preferably 0.0001% or less by weight. This is because the oxygen in the ground state has two unpaired electrons, and the oxygen content left after the heat treatment promotes oxidation decomposition reaction of the liquid electrolyte in the state where a continuous load is applied at high temperatures to increase the amount of the generated gas. A hydrogen gas or hydrogen-containing inert gas may be used instead of the above inert gas as means for leaving as small an oxygen content as possible. The reason for this is that the characteristics of strong reduction of hydrogen gas promotes the deoxidation.

The graphite powder obtained through such two stages of the reaction process has the reduced density of the localized electrons, and can thereby achieve a relative ratio (ΔH_{40K}/ΔH_{296K}) of 2.1 or more calculated by the ESR method. In the lithium secondary battery applying such a graphite powder to the positive electrode thereof, an increase in internal pressure is inhibited in the state where a continuous load is applied at the high temperature. As a result, a leak of liquid electrolyte and rupture do not occur. The reason for this is not apparent. However, it is presumed that the reason that the oxygen selectively reacts with the localized electrons existing on the surface of the graphite to form an alkyl group in the process of deoxidation. Specifically, when the alkyl group is formed at a site where the localized electrons existed before such two stages of the reaction process mentioned above, the density of the localized electrons on the surface of the graphite powder is reduced. In addition, the conduction electrons cannot move to the molecular orbital of the carbon atoms constructing the alkyl group. As a result, the possibility for the conduction electrons to participate in the oxidation decomposition reaction of the liquid electrolyte on the surface of the graphite powder is reduced.

The raw material of the graphite powder used in the first and second synthesis methods can be synthesized by graphitizing an graphitizing carbon material to pulverize the same, or by pulverizing an graphitizing carbon material to graphitize the same. The graphite powder obtained by purifying natural graphite yielded in nature to a purity level of at least 99% or more as a fixed carbon component and pulverizing the same is also applicable. Any of usual pulverizers including a pin mill, a ball mill, and colloidal mill is available as the methods of pulverization.

Various kinds of pitches such as coal-tar pitch or petroleum pitch are typical of the starting raw material of the graphitizing carbon material. These pitches are obtained through purifying or reforming processes such as distillation, extraction, thermal decomposition, and dry distillation of raw materials including coal-tar or crude oil. An organic polymer compounds such as condensed polynuclear aromatic resin (COPNA resin) and polyvinyl chloride resin are also usable. The COPNA resin is formed using aromatic compounds such as naphthalene, phenanthrene, anthracene, pyrene, perylene, and acenaphthylene as a raw material. These starting raw materials pass a liquid phase at about 350° C. in the course of heat treatment, and thereby allow the formation and three-dimensional stacking of polycondensed polycyclic hydrocarbon compounds to easily advance. Subsequently, an anisotropic region is formed to synthesize a carbon precursor. The precursor will be in the state where it easily allows graphite materials to be provided by subsequent heat treatment. The above anisotropic region is called carbonaceous mesophase. The larger the anisotropic region (specifically, the closer to a bulk mesophase state), the higher completeness of a crystal structure of the graphite material is obtained after graphitization. Thus, the raw material having a larger anisotropic region is particularly preferable as the raw material of the graphite powder specified in the present invention.

The above organic material as a starting raw material is carbonized in an atmosphere of an inert gas such as a nitrogen or argon gas or helium gas at 200° C. to 700° C., and subsequently calcined at a maximum reached temperature of about 900° C. to 1500° C. to synthesize the graphitizing carbon. Mesophase pitch based carbon fibers, vapor grown carbon fibers, thermal decomposed carbon, mesocarbon microbeads, pitch cokes or petroleum cokes, or needle cokes or the like which are obtained as carbon materials are also graphitizing carbon materials. They are suitable for the raw material of the graphite powder specified in the present invention. The graphite powder to be prepared for oxidation and heat treatment can be obtained by graphitization of graphitizable carbon materials in an inert gas atmosphere at 2500° C. or more, preferably at 2800° C. or more, by pulverizing the same and by controlling the particle size of the same as necessary. The graphite powder obtained by pulverizing these graphitizing carbon materials, and by graphitizing the same after controlling the particle size as necessary, can also suitably be used.

On the other hand, in addition to hexagonal graphite which is the original graphite crystal, rhombohedral graphite is also introduced into the graphite powder pulverized after graphitization of graphitizable carbon material. The unit cell of the graphite crystal is the hexagonal crystal. When such hexagonal graphite is pulverized, shear deformation occurs along the layer plane in reflection of very weak bond between the graphite layer planes, and a rhombohedral structure emerges. It is presumed that, because carbon-carbon bond in the layer plane is very strong, parts of hexagonal net planes each having high planarity are shifted in a continuation of the storage of the dynamic energy provided by the pulverization, and that thereby a rhombohedral structure is introduced. Thus, a large quantity of dangling bonds and lattice defects are formed in the surfaces of the particles of the rhombohedral graphite and in the interior of the solid phase of the crystallite thereof.

It is more preferable, therefore, that the existence ratios of the rhombohedral graphite in the graphite powder to be prepared for oxidation and heat treatments and in the graphite powder after the above treatments. This is because the rhombohedral graphite has a high density of the localized electrons so that these unpaired electrons promote the oxidation decomposition reaction of the solvent during the high temperature floating charge. Note that, the existence ratio of the rhombohedral structure and the hexagonal structure can be calculated by comparing the intensity ratio of the diffraction peak obtained by X-ray wide-angle diffractometry with the theoretical intensity ratio. The existence ratio of the rhombohedron is preferably 25% or less, more preferably 20% or less.

The positive electrode obtained in the above manner is kneaded and molded together with an electroconductive agent and a binder to be built in a battery as a positive electrode mixture. The graphite material of the positive electrode originally has a high electroconductivity so that the electroconductive agent is considered not to be required in this case. However, it may be used as necessary taking into consideration of the application of the battery.

As an electroconductive agent, various kinds of graphite materials and carbon black have usually been used. In a case of the non-aqueous electrolyte secondary battery according to the present invention, the graphite material functions as a positive electrode. Thus, it is not preferable to mix other graphite material as an electroconductive agent. If an electroconductive material needs to be used, therefore, electroconductive carbon black is preferably used.

What is used as the electroconductive carbon black included channel black, oil furnace black, lamp black, thermal black, acetylene black, ketjen black and the like.

However, part of the petroleum pitch or coal-tar pitch is used as a raw material of the carbon blacks other than acetylene black. For this reason, in some cases, impurities such as sulfur compound or nitrogen compound may be mixed in a large amount. It is thus preferable to remove these impurities before using them.

The acetylene black is synthesized by continuous thermal decomposition using acetylene only as a raw material, therefore hardly mixed with impurities. Moreover, it has such an developed chain structure of the particles, and has excellent ability to hold liquid electrolyte, and low electric resistance. Thus the acetylene black is particularly preferable as this kind of the electroconductive agent.

The mixing ratio of these electroconductive agent and the graphite material according to the present invention may suitably be set corresponding to the application of the battery. In a case where the improvements, particularly, in a quick charge characteristic and a heavy load discharge characteristic are required of a completed battery, an electroconductive agent is preferably mixed with the graphite material according to the present invention in an amount that allows the agent to provide a sufficient effect of imparting electroconductivity to construct the positive electrode mixture. However, it is not preferable that the electroconductive agent is included there in a large amount than necessary. This is because, in such a case, the amount of the positive electrode material to be filled is reduced according to the excessive amount so that the capacity (volume energy density) is reduced.

A prerequisite for the binder is that the agent is not dissolved in the liquid electrolyte, and that the agent has excellent resistance to the solvent. Organic polymer compounds are suitable as a material which meets the prerequisite. The organic polymer compounds include: fluorine-based resin such as polyvinylidene difluoride (PVdF), polytetrafluoroethylene (PTFE) and polyvinyl fluoride (PVF); the alkali metal salt or ammonium salt of carboxymethylcellulose; polyimide resin; polyamide resin; polyacrylic acid; and sodium polyacrylate.

As described above, the positive electrode mixture is formed of the graphite material according to the present invention, and additionally, the binder. The electroconductive agent is added as necessary. Subsequently, the positive electrode mixture is built in a battery after mixed and molded.

On the other hand, for a negative electrode, any material which can electrochemically intercalate and deintercalate lithium ions can be used. Examples of a material which can be used for the negative electrode include lithium metal, lithium-aluminum alloy, a graphite material, an graphitizing carbon material, a non-graphitizing carbon material, niobium pentoxide (Nb₂O₅), lithium titanate (Li₄Ti₅O₁₂), silicon monoxide (SiO), tin monoxide (SnO), the composite oxide of tin and lithium (Li₂SnO₃), the composite oxide of lithium, phosphorus, and boron (for example, LiP_{0.4}B_{0.6}O_{2.9}).

The carbon material such as the graphite material, an graphitizing carbon material and a non graphitizing carbon material has the basic potential for the intercalation and deintercalation of lithium, high reversibility and large. capacity. In a case where it is used in a negative electrode of the present invention, it can exhibit a very large effect.

Examples of the carbon materials include: various kinds of suitably pulverized graphite materials; carbon materials; synthetic graphite material synthesized by graphitization of the above carbon materials; and the mixture thereof. The graphite materials include natural graphite, synthetic graphite, and expanded graphite. The carbon materials include, for example, carbonized mesocarbon microbeads, mesophase pitch-based carbon fibers, vapor grown carbon fibers, pyrolytic graphite, petroleum cokes, pitch cokes, and needle cokes.

In the case of a negative electrode, a negative electrode mixture is formed of the materials exemplified above, the binder, and the electroconductive agent as necessary. They are mixed and molded. Subsequently, the mixture is built in a battery. As the binder and the electroconductive agent in this case, the materials exemplified above which are used to synthesize the positive electrode mixture can be used without modification.

Examples of a non-aqueous electrolyte include a non-aqueous liquid electrolyte prepared by dissolving a lithium salt in an organic solvent, and a solid electrolyte prepared by dissolving a lithium salt in a lithium ion conductive solid material.

The non-aqueous liquid electrolyte is prepared by dissolving a lithium salt in an organic solvent. Any of the above organic solvent and the lithium salt can be used, as long as it is usually used in this kind of battery. Examples of an organic solvent include propylene carbonate (PC), ethylene carbonate (EC), butylene carbonate (BC), γ-butyrolactone (GBL), vinylene carbonate (VC), acetonitrile (AN), dimethyl carbonate (DMC), diethyl carbonate (DEC), ethyl methyl carbonate (EMC), methyl propyl carbonate (MPC), derivatives thereof, and the mixed solvent thereof.

Note that, any lithium salt can be used, as long as it is usually used in this kind of battery also. Examples of the lithium salt include LiPF₆, LiBF₄, LiClO₄, LiGaCl₄, LiBCl₄, LiAsF₆, LiSbF₆, LiInCl₄, LiSCN, LiBrF₄, LiTaF₆, LiB(CH₃)₄, LiNbF₆, LiIO₃, LiAlCl₄, LiNO₃, LiI, and LiBr.

The amount of these salts dissolved in the organic solvent may suitably be set within a range of 0.5 mol/L to 4.0 mol/L as in the case of the conventional non-aqueous electrolyte secondary battery, but preferably 0.8 mol/L to 3.5 mol/L, more preferably 1.0 mol/L to 3.0 mol/L.

When the positive electrode section and negative electrode section which are constructed in the above manner are disposed in an air-tight container via a non-aqueous electrolyte in which a lithium salt is dissolved, the non-aqueous electrolyte secondary battery applying the present invention is completed.

### Embodiments

The embodiment of the non-aqueous electrolyte secondary battery according to the present invention will hereinafter specifically be described.

1. Method of Measuring Physical Properties

1-1. Method of Measuring ESR

ESR measurement was performed using a sample tube which was filled with helium gas after vacuumed by means of a diffusion pump for one hour. ESP350E of Bruker Japan Co., Ltd. was used as an ESR equipment. HP5351B of Hewlett-Packard Development Company, L.P. was used as amicrowave frequency counter. ER035M of Bruker Japan Co., Ltd. was used as a gauss meter. ESR910 of Oxford Instrument Co., Ltd. was used as a cryostat.

Measurement was performed under the following conditions: a microwave, 9.47 GHz, 1 mW; a sweeping time, 83.886 second×2 times; and magnetic field modulation, 100 kHz, 10G. Measurement temperatures were 296 K, 280 K, 240 K, 200 K, 160 K, 120 K, 80 K, 40 K, 20 K, 10 K, and 4.8 K. The full width of half maximum intensity of an absorption spectrum was read in a manner as follows. The obtained spectrum was read by means of a digitizer. By once integrating the read value to a magnetic field H, an absorption curve was depicted. Thereafter, the width of the graphic was read at a position of a half height of the graphic from the background by the unit (gauss) of the magnetic field.

1-2. Method of Calculating the Crystallite in a c Axial Direction Lc (112)

About 10% by weight of X-ray standard high purity silicon powder (available from Furuuchi Chemical Co., Ltd., 99.999%) was added as -an internal standard material to a sample. Then, it was mixed, and the mixture was filled in a sample cell. Subsequently, a wide-angle X-ray diffraction profile was obtained using a CuKa line monochromatized with a graphite monochromator as a line source by reflection diffractometer. A voltage of 40 KV and a current of 40 mA were applied to an X-ray tube. A divergence slit of 2°, a scattering slit of 2°, and a receiving slit of 0.3 mm were set to perform scanning at a scanning rate of 0.25° per minute from 81° to 89° in terms of 2θ. In the obtained diffraction graphic, according to Non-patent Document 5, the diffraction angle and full width of half maximum intensity of the (112) diffraction line of the graphite material which appeared around 83.6° of 20 were corrected by the (422) diffraction line of the silicon powder which appeared around 88.1° of 20 to calculate the size Lc (112) of crystallite in a c axial direction.

1-3. Method of Measuring Particle Size Average (Volume Average Diameter: d50)

The average particle diameters of the raw cokes (including a carbon precursor) and the graphite material obtained in the example were measured using a laser diffraction type particle size distribution meter (Micro Trac MT2000 of NIKKISO CO., LTD.)

2. Production of the Graphite Powder

2-1. Method of Synthesizing the Graphite Powder in Relation to the First Synthesis Method

Each of the graphite A to F described below was synthesized as the graphite powder for a positive electrode. Table 1 shows the absorption intensity, full width of half maximum intensity, size Lc (112) of a crystallite and average particle diameters which were measured by the ESR method with respect to these graphite powder (A to F).

TABLE 1
Full width of half maximum intensity (FWHM) and intensity of ESR absorption spectrum
of synthetic graphite powder at each temperature

| | | Temperature K | | | | | |
|---|---|---|---|---|---|---|---|
| | | 296 | 280 | 240 | 200 | 160 | 120 |
| Graphite A | FWHM (gauss) | 49.6 | 50.8 | 54.8 | 56.9 | 64.3 | 74.5 |
| | Absorption intensity (spins/g) | 5.41E+18 | 5.41E+18 | 5.41E+18 | 5.22E+18 | 5.82E+18 | 5.96E+18 |
| Graphite B | FWHM (gauss) | 39.5 | 41.7 | 46.4 | 51.9 | 58.1 | 68.1 |
| | Absorption intensity (spins/g) | 5.74E+18 | 5.74E+18 | 5.95E+18 | 5.84E+18 | 6.6E+18 | 6.6E+18 |
| Graphite C | FWHM (gauss) | 86.3 | 89.6 | 93.4 | 96.5 | 108.4 | 126.7 |
| | Absorption intensity (spins/g) | 4.81E+18 | 5.03E+18 | 4.99E+18 | 4.85E+18 | 4.99E+18 | 4.89E+18 |
| Graphite D | FWHM (gauss) | 45.9 | 48.2 | 53.6 | 58.6 | 69.4 | 85.2 |
| | Absorption intensity (spins/g) | 5.31E+18 | 5.41E+18 | 5.41E+18 | 5.38E+18 | 5.72E+18 | 5.8E+18 |
| Graphite E | FWHM (gauss) | 61.3 | 63.4 | 66.7 | 71.7 | 82.9 | 94.6 |
| | Absorption intensity (spins/g) | 4.93E+18 | 5.24E+18 | 5E+18 | 4.87E+18 | 5.02E+18 | 5.01E+18 |
| Graphite F | FWHM (gauss) | 99.3 | 101.9 | 105.8 | 113 | 121.5 | 132.6 |
| | Absorption intensity (spins/g) | 5.14E+18 | 5.4E+18 | 5.4E+18 | 5.54E+18 | 5.62E+18 | 5.63E+18 |

| | | Temperature K | | | | |
|---|---|---|---|---|---|---|
| | | 80 | 40 | 20 | 10 | 4.8 |
| Graphite A | FWHM (gauss) | 96.1 | 101 | 100 | 98.8 | 63.8 |
| | Absorption intensity (spins/g) | 6.55E+18 | 6.89E+18 | 1.04E+19 | 1.59E+19 | 1.84E+19 |
| Graphite B | FWHM (gauss) | 112 | 131 | 113 | 115 | 71.7 |
| | Absorption intensity (spins/g) | 5.57E+18 | 5.9E+18 | 8.35E+18 | 1.57E+19 | 1.94E+19 |
| Graphite C | FWHM (gauss) | 154.3 | 158.2 | 135.3 | 123 | 83.1 |
| | Absorption intensity (spins/g) | 5.13E+18 | 4.79E+18 | 7.07E+19 | 1.12E+19 | 1.74E+19 |
| Graphite D | FWHM (gauss) | 106 | 120 | 110 | 107 | 75.3 |
| | Absorption intensity (spins/g) | 5.5E+18 | 6.2E+18 | 1.07E+19 | 1.64E+19 | 2.26E+19 |
| Graphite E | FWHM (gauss) | 117.1 | 117.2 | 111.3 | 106.3 | 63.8 |
| | Absorption intensity (spins/g) | 5.16E+18 | 5.01E+18 | 7.56E+19 | 1.37E+19 | 1.79E+19 |
| Graphite F | FWHM (gauss) | 147 | 162 | 130.3 | 127.5 | 94 |
| | Absorption intensity (spins/g) | 4.45E+18 | 5.5E+18 | 1.1E+19 | 1.69E+19 | 2.69E+19 |

Table 2 shows the relative ratio (ΔH₄₀ₖ/ΔH_{296K}) of the full width of half maximum intensity ΔH₄₀ₖ of the peak measured at a temperature of 40 K to the full width of half maximum intensity ΔH_{296K} of the peak measured at a temperature of 296 K.

TABLE 2
Floating charge characteristics at 60° C.

| | | | | Discharge | Discharge | |
|---|---|---|---|---|---|---|
| | Particle | Crystallite | Relative | capacity | capacity | Ratio of |
| | size | size | ratio of | at 20th | at 31st | residual |
| | average | Lc (112) | FWHM* | cycle | cycle | capacity |
| Graphite/Battery | (μm) | (nm) | ΔH₄₀ₖ/ΔH_{296K} | (mAh) | (mAh) | (%) |
| A | 25.4 | 38 | 2.0 | 59.3 | 55.1 | 80.5 |
| B | 25.4 | 36 | 3.3 | 58.4 | 56.4 | 96.6 |
| C | 25.4 | 58 | 1.8 | 59.5 | 50.7 | 69.4 |
| D | 25.4 | 74 | 2.6 | 59.8 | 56.5 | 94.5 |
| E | 25.4 | 72 | 1.9 | 58.1 | 42.6 | 73.3 |
| F | 3.2 | 21 | 1.6 | 59.4 | — | — |

*“Full Width of Half Maximum intensity” is abbreviated to FWHM.

Graphite A:

Mesophase pitch 1029 of MITSUBISHI GAS CHEMICAL COMPANY, INC. was heated to 800° C. at a temperature increase rate of 100° C./hour, and maintained at 800° C. for 1 hour. Subsequently, it was left to cool to room temperature to obtain block-like pitch cokes. This pitch cokes was put in a graphite crucible. At this time, the gap between the wall surface of the crucible and the lid was closed up with the graphite powder.

This crucible is mounted in an electric furnace, and heated to 3000° C. at a temperature increase rate of 300° C./hour in argon gas stream. Then, it is maintained at 3000° C. for 10 hours. Subsequently, it was left to cool to room temperature. The graphite powder adhered on the circumferential surface of the obtained block-like graphite was removed using an air gun. The block-like graphite was coarsely crushed with a stamp mill, and then pulverized with a jet mill. The obtained powder was subjected to be controlled particle size by sieve operation to obtain graphite powder having an average particle diameter of 25.4 μm. This graphite powder is graphite A.

Graphite B:

The graphite A is put in a graphite crucible, and heated to 1000° C. at a temperature increase rate of 500° C./hour in a hydrogen atmosphere. Then, it is maintained at 1000° C. for 2 hours. Subsequently, it was left to cool to room temperature. This graphite powder is graphite B.

Graphite c:

The graphite A was put in a graphite crucible, and heated to 1000° C. at a temperature increase rate of 500° C./hour in a nitrogen atmosphere. Then, it was maintained at 1000° C. for 2 hours. Subsequently, it was left to cool to room temperature.

This graphite powder is graphite C.

Graphite D:

The graphite A was put in a graphite crucible, and the interior of the electric furnace was maintained in a decompression state of 50 torr or less. Then, it is heated to 1000° C. at a temperature increase rate of 500° C./hour in the above state, and maintained at 1000° C. for 2 hours. Subsequently, it was left to cool to room temperature. This graphite powder is

graphite D.

Graphite E

The graphite A is put in a graphite crucible, and heated to 1000° C. at a temperature increase rate of 500° C./hour in an argon atmosphere. Then, it is maintained at 1000° C. for 2 hours. Subsequently, it was left to cool to room temperature. This graphite powder is graphite E.

Graphite F:

The graphite A was further pulverized with a jet mill to obtain graphite powder having an average particle diameter of 3.2 μm. This graphite powder is graphite F.

2-2. Method of Synthesizing the Graphite Powder in Relation to the Second Synthesis Method

Each of the graphite powder G and the following described below was synthesized as the graphite powder for a positive electrode. Table 3 shows the relative ratios (ΔH₄₀ₖ/ΔH_{296K}) of the full width of half maximum intensity ΔH₄₀ₖ of the absorption curve measured at a temperature of 40 K to the full width of half maximum intensity ΔH_{296K}of the absorption curve measured at a temperature of 296 K by the ESR method, the crystallite size Lc (112), and a particle size average with respect to each graphite powder.

TABLE 3
Physical property values of the positive electrode graphite material and floating charge
characteristics at 60° C. of a battery

| | | | | Discharge | Discharge | |
|---|---|---|---|---|---|---|
| | Particle | | Relative | capacity | capacity | Ratio of |
| | size | Crystallite | ratio of | at 20th | at 31st | residual |
| | average | size Lc | FWHM* | cycle | cycle | capacity |
| Graphite/Battery | (μm) | (112) (nm) | ΔH₄₀ₖ/ΔH_{296K} | (mAh) | (mAh) | (%) |
| G | 27.5 | 39 | 2 | 54.3 | 42.6 | 78.5 |
| H | 26.8 | 35 | 3.6 | 59.6 | 56.2 | 96.2 |
| I | 33.8 | 48 | 2.1 | 55.1 | 43.9 | 87.5 |
| J | 29.6 | 47 | 2.7 | 58.7 | 55.8 | 95.1 |
| K | 17.5 | 16 | 1.9 | 46.4 | 31.3 | 67.5 |
| L | 16.8 | 17 | 2.2 | 49.7 | 43.8 | 90.3 |
| M | 25.4 | 17 | 2 | 45.2 | 33.7 | 74.6 |
| N | 23.1 | 23 | 2.3 | 47.9 | 43.3 | 90.4 |

*“Full Width of Half Maximum intensity” is abbreviated to FWHM.

Graphite G:

Mesophase pitch 1029 of MITSUBISHI GAS CHEMICAL COMPANY, INC. was heated to 800° C. at a temperature increase rate of 100° C./hour, and maintained at 800° C. for 1 hour. Subsequently, it was left to cool to room temperature to obtain block-like pitch cokes. This block-like cokes were once coarsely crushed with a stamp mill, and further pulverized with a jet mill to obtain powder cokes. This powder was put in a graphite crucible, and heated to 3000° C. at a temperature increase rate of 300° C./hour in an argon gas atmosphere. Then, it was maintained at 3000° C. for 1 hour, and subsequently left to cool to room temperature. This graphite powder is graphite G.

Graphite H:

The graphite G was put in a crucible. The crucible was mounted in an electric furnace, and heated to 600° C. at a temperature increase rate of 100° C. in an air stream. Then, it was maintained at 600° C. for 3 hours, and left to cool to room temperature. Subsequently, the atmosphere was changed to a hydrogen gas stream, and the crucible was heated to 1000° C. at a temperature increase rate of 100° C. . It was maintained at 1000° C. for 1 hour, and left to cool to room temperature. This graphite powder is graphite H.

Graphite I:

Anthracene (TOKYO CHEMICAL INDUSTRY CO., LTD) and 9, 10-dihydroanthracene (KANTO CHEMICAL CO., INC) were mixed in a molar ratio of 1:1. The mixture and polyphosphoric acid were mixed in a weight ratio of 7:100, and the obtained mixture was heated at 140° C. for 24 hours. After it was left to cool, distilled water was added, and the mixture was further stirred. After residual polyphosphoric acid was decomposed to phosphoric acid, 10% by weight of ammonium hydrogen carbonate solution was added to residual black block-like resin to neutralize phosphoric acid. After the residual black block-like resin was refluxed using methanol, unreacted materials were extracted further using methanol by means of a Soxhlet extractor. The obtained black block-like resin was heated to 800° C. at a temperature increase rate of 50° C./hour, and then maintained at 800° C. for 1 hour. Subsequently, it was left to cool to room temperature to synthesize a block-like carbon block. This block was once coarsely crushed with a stamp mill, and then pulverized with a jet mill to obtain carbon powder. This carbon powder was put in a graphite crucible, and further mounted in an electric furnace. The crucible was heated to 3000° C. in a nitrogen stream, and maintained at 3000° C. for 5 hours. Subsequently, it was left to cool to room temperature. This graphite powder is graphite I.

Graphite J:

The graphite I was put in a crucible, and mounted in an electric furnace. The crucible was heated to 650° C. at a temperature increase rate of 100° C./hour in an air stream, and maintained at 650° C. for 3 hours. Then, it was left to cool to room temperature. Subsequently, after the atmosphere was changed to a nitrogen gas stream, the crucible was heated to 1500° C. at a temperature increase rate of 100° C./hour, and maintained at 1500° C. for 1 hour. Then, it was left to cool to room temperature. This graphite powder is graphite J.

Graphite K:

Coal-tar pitch “Pellet” of THE KANSAI COKE AND CHEMICALS CO., LTD. was heated to 800° C. at a temperature increase rate of 100° C./hour, and maintained at 800° C. for 1 hour. Subsequently, it was left to cool to room temperature to obtain block-like pitch cokes. The pitch cokes were put in a graphite crucible. The gap between the wall surface of the crucible and the lid was closed up with the graphite powder. This crucible was mounted in an electric furnace, and heated to 3000° C. at a temperature increase rate of 300° C./hour in an argon gas stream. Then, it was maintained at 3000° C. for 5 hours. Subsequently, it was left to cool to room temperature. The graphite powder adhered on the circumferential surface of the obtained block-like graphite was removed using an air gun. The block-like graphite was coarsely crushed with a stamp mill, and then pulverized with a jet mill. This graphite powder is graphite K.

Graphite L:

The graphite K was put in a crucible. The crucible was mounted in an electric furnace, and heated to 650° C. at a temperature increase rate of 100° C./hour in an air stream. Then, it was maintained at 650° C. for 3 hours, and then left to cool to room temperature. Subsequently, the interior of the electric furnace was decompressed such that the pressure was maintained at a pressure of 10 torr or less, and the crucible was heated to 1000° C. at a temperature increase rate of 100° C./hour. It was maintained at 1000° C. for 1 hour, and left to cool to room temperature. This graphite powder is graphite L.

Graphite M:

Mesophase pitch 1029 of MITSUBISHI GAS CHEMICAL COMPANY, INC. was heated to 800° C. at a temperature increase rate of 100° C./hour, and maintained at B00° C. for 1 hour. Subsequently, it was left to cool to room temperature to obtain block-like pitch cokes. The pitch cokes were put in a graphite crucible. The gap between the wall surface of the crucible and the lid was closed up with the graphite powder. This crucible was mounted in an electric furnace, and heated to 2800° C. at a temperature increase rate of 300° C./hour in an argon gas stream. Then, it was maintained at 2800° C. for 5 hours. Subsequently, it was left to cool to room temperature. The graphite powder adhered on the circumferential surface of the obtained block-like graphite was removed using an air gun. The block-like graphite was coarsely crushed with a stamp mill, and then pulverized with a jet mill. This graphite powder is graphite M.

Graphite N:

Potassium hydroxide powder was crushed with a stamp mill. The obtained fine powder and the graphite M were mixed in a weight ratio of 1:1. The powder mixture was put in a crucible, and the crucible was mounted in an electric furnace. Then, it was heated to 800° C. at a temperature increase rate of 100° C./hour in an argon gas stream, and maintained at 800° C. for 5 hours. Subsequently, it was continuously heated to 1500° C. at a temperature increase rate of 100° C./hour, and maintained at 1500° C. for 5 hours. Then, it was left to cool to room temperature. This graphite powder is graphite N.

3. Fabrication of a Battery

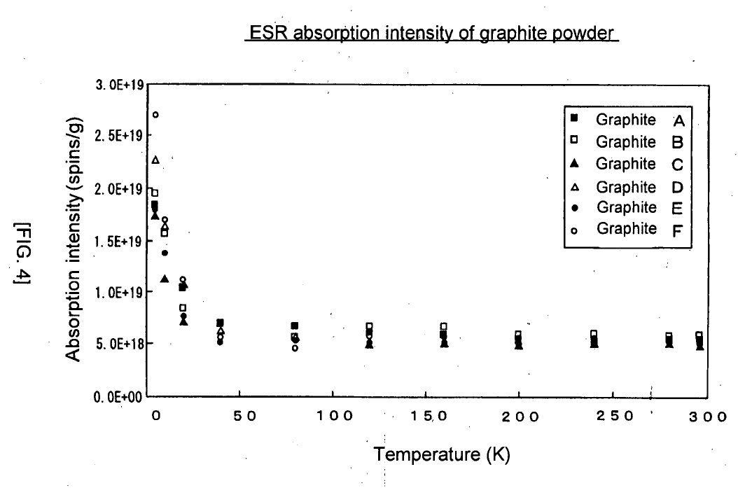

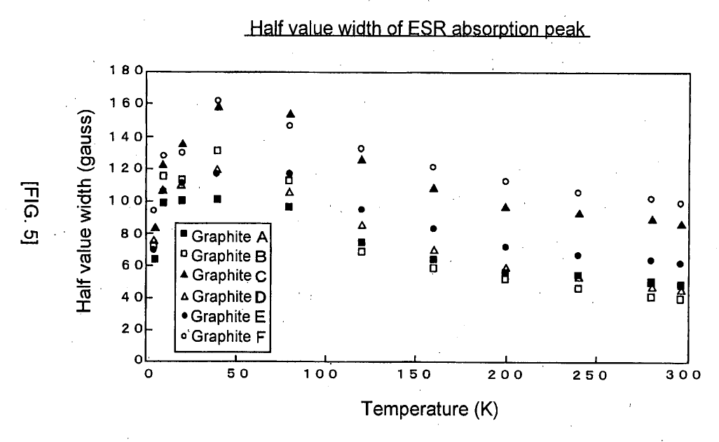

FIG. 3 is a cross sectional view of the fabricated non-aqueous electrolyte secondary battery. It is constructed as a battery 18650 model lithium secondary battery shown in FIG. 3. A positive electrode section 11 and a negative electrode section 13 were formed in the following manner.

3-1. Anode Section 11

The graphite powder of the positive electrode material and carboxymethylcellulose (SEROGEN 4H of DAI-ICHI KOGYO YAKUHIN CO., LTD.) of a binder were mixed in a weight ratio of 97:3, and ion-exchange water was added thereto to make a paste. This paste was applied on both sides of an aluminum foil having a thickness of 20 μm. It was dried and rolled to synthesize a belt-like sheet electrode by cutting it in a width of 56 mm. The aluminum foil forms a power collector.

The mixture on a part of the sheet electrode is removed by scratching it in a direction perpendicular to a length direction. An aluminum-made positive electrode lead plate 44 is attached thereto by ultrasonic welding method. The graphite powder used was each of the above described graphite A to N. A battery was fabricated using each material. The battery using graphite A for its positive electrode is called battery A in accordance with the name of the used graphite.

3-2. Cathode Section 13

A non-graphitizing carbon material of a negative electrode material (PIC of KUREHA CORPORATION) and polyvinylidene difluoride resin (KF#1100 of KUREHA CORPORATION) were mixed in a weight ratio of 95:5, and N-methyl-2-pyrrolidinone was added thereto as a solvent to knead the mixture in a paste. This paste was applied on both sides of a copper foil having a thickness of 14 μm. It was dried and rolled to produce a belt-like sheet electrode by cutting it in a width of 54 mm.

The mixture on a part of the sheet electrode is removed by scratching it in a direction perpendicular to a length direction. A nickel-made negative electrode lead plate 5 is attached thereto by ultrasonic welding method.

The above positive electrode section 11 and negative electrode section 13 are wound in a spiral form via a polyolefin-based separator 12. This wound electrodes are inserted into a stainless steel battery case 51. A polyethylene microporous film was used for the separator 12. The negative electrode lead plate 45 was welded in the center of the circle bottom surface of the battery case 51 by resistance welding method. The battery case 51 serves as both a negative electrode terminal and a negative electrode case. A polypropylene insulation bottom plate, which is designated at a numeral 53, has a hole having the same area as that of the space created during winding.

After performing the above steps, a liquid electrolyte is injected. The used liquid electrolyte is the one synthesized by dissolving LiPF₆ in a concentration of 2 mol/L in the mixed solvent prepared by mixing propylene carbonate (PC) and ethyl methyl carbonate (EMC) in a volume ratio of 1:4.

Subsequently, the positive electrode lead plate 44 is welded to an aluminum base section 54 by a laser welding method. Furthermore, an anti-explosion type lid element provided with a current cutoff mechanism is fitted to a gasket 55 to seal the case 51. The anti-explosion type lid element has a metallic positive electrode terminal plate 56, an intermediate pressure sensitive plate 57, electroconductive members (58, 54) including a protrusion 58 protruding upward and a base section 54, and an insulative gasket 55.

A fixation plate 59 is mounted between the intermediate pressure sensitive plate 57 and the base section 54. A gas releasing hole (not shown) is formed in the positive electrode terminal plate 56 and the fixation plate 59. The electroconductive members (58, 54) has the protrusion 58, the upper surface of which is exposed from the upper surface of the fixation plate 59, and the base section 54, the bottom surface of which is exposed from the bottom surface side of the fixation plate 59.

The gasket 55 is fitted in the inner circumference of the opening portion of the battery case 51. The fixation plate 59 is fitted in the inner circumference of the gasket 55. The intermediate pressure sensitive plate 57 and the positive electrode terminal plate 8 are stacked on the fixation plate 59.

The electroconductive members (58, 54) and the intermediate pressure sensitive plate 57 are connected to each other at the protrusion 58 of the electroconductive members (58, 54). Both are electrically communicated with each other at only the contact portion including a connection portion 60 thereof. The positive electrode lead plate 44 is connected to the base section 54 of electroconductive members (58, 54) at the edge thereof. The gasket 55 is compressed by inwardly crimping the opening portion of the battery case 51 (negative electrode case) The battery case 51 is thereby sealed with the above lid element.

When the internal pressure inside the battery case 51 reaches a predetermined pressure, the outwardly swelling intermediate pressure sensitive plate 57 is broken around the connection portion 60 formed with the protrusion 58 of the electroconductive members (58, 54). The electrical communication path between the positive electrode lead plate 44 and the positive electrode terminal plate 56 is thereby cut off.

The polypropylene insulation bottom plate 53 has a hole having the same area as that of the space created during winding. This insulation plate 53 is inserted so that a wound electrode group and the positive electrode lead plate can not cause a short circuit.

4. Confirmation Test of a Discharge Capacity

The obtained cell was put in a temperature-controlled chamber which has been set at 25° C., and charge/discharge cycle was started. In a first charge cycle, an electric capacity equivalent to 15 (mAh/g) was charged at a current value equivalent to a current density of 50 (mA/g) based on the overall weight of the positive electrode filled in the cell. A charging time is 18 minutes.

Then, a discharge cycle was performed at the same current value as above until the cell voltage became 3.0V. From this until a 10th cycle, a constant current charge/discharge cycle was performed at the same charge/discharge current value as that of the first cycle using a final charge voltage of 4.2V and a final discharge voltage of 3.0V.

From an 11th cycle, was 10 times repeated the charge/discharge cycle where a constant current/constant voltage charge cycle was performed at a current value of 1A and a voltage value of 4.2V for 10 minutes, and where discharge was performed at a constant current value of 1A. The discharge capacity of a 20th cycle was considered to be the discharge capacity prior to 60° C. floating charge test, and this was a reference for making comparison with the discharge capacity obtained from the floating charge test and the subsequent charge/discharge test. The discharge capacity of the final cycle, that is, of the 20th cycle of each specification is shown in a foregoing Table 2.

5. Method of Performing Floating Charge Test at 60° C. The floating charge test was performed in a 21st cycle. A cell was mounted in a 60° C. temperature-controlled chamber, and thereafter left to stand for 5 hours. A floating charge was started after 5 hours. The charge conditions were the same as those in the charging method used in 11th to 20th cycles. However, a charging time was 100 hours. Subsequently, the cell was allowed to be at rest for only 1 minute, and discharge was thereafter performed under the same conditions as those in the discharging method used in the 11th to 20th cycles while the cell was maintained at 60° C.

6. Confirmation Test of Discharge Capacity after Floating Charge Test

The cell was moved to a 25° C. temperature-controlled chamber, and left to stand for 5 hours. Then, 10 charge/discharge cycles were performed under the same conditions as those in the charging/discharging method used in the 11th to 20th cycles. The number of charge/discharge cycles performed in foregoing items 4 and 5 is 31 cycles in total.

The discharge capacity obtained in a 31st cycle was considered to be the discharge capacity obtained after performing the 60° C. floating charge, and this was a reference to quantitatively understand the effect that the 60° C. floating charge had. Specifically, this capacity was lower than the discharge capacity of the 20th cycle, that is, the discharge capacity obtained before performing the 60° C. floating charge test. The capacity maintaining rate (restoration rate) after performing the floating charge was calculated using the following equation.
(Capacity maintaining rate)=(Discharge capacity of 31st cycle)/(Discharge capacity of 20th cycle)×100

Table 2 shows the ratio of residual capacity of batteries A to F after performing floating charge.

7. Results and Summary of the Examples

7-1. Example of the First Synthesis Method

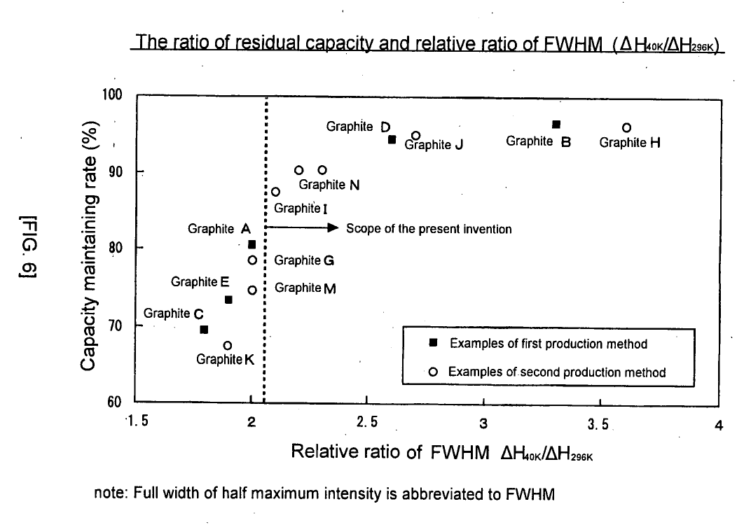

FIG. 4 shows the temperature-dependence of the absorption intensity (the absorption intensity measured by the ESR method) of each graphite powder (A to F). Any of the graphite materials did not have temperature-dependence of the absorption intensity within a temperature range of 296 K to 40 K, and there was no change in the absorption intensity even when the temperature was decreased.

However, within the extremely low temperature range of 20 K or less, the absorption intensity was rapidly increased as the temperature was decreased. Thus, it is estimated that the conduction electrons make a large contribution to the ESR absorption spectrum down to about 40 K. The reason why the absorption intensity was rapidly increased within the extremely low temperature range of 20 K or less as the temperature was decreased was that the localized electrons made additional contribution, although the conduction electrons made unchanged contribution.

It is presumed that although the conduction electrons make most of contribution to the ESR absorption intensity at a temperature of 40 K, the localized electrons make no small contribution. The magnitude of the contribution can be understood using the change in the full width of half maximum intensity.

FIG. 5 shows the temperature dependence of the full width of half maximum intensity of each graphite powder (A to F). For example, when comparison is made between graphite A and B, there is no significant difference in both of absorption intensity and full width of half maximum intensity between them within a temperature range of 120 K or more. However, at temperatures of 80 K and 40 K, the full width of half maximum intensity of the graphite B is larger than that of graphite A. A significant difference in the absorption intensity is not observed in FIG. 4. This is because the graphite A contains such a larger number of the localized electrons that the localized electrons have a strong effect on the full width of half maximum intensity at 40 K and 80 K at which the contribution of localized electrons do not appear in the absorption intensity. However, the contribution is so extremely small as not to be reflected on the absorption intensity of FIG. 4.

As described above, a temperature of 40 K is the one at which the contribution of the localized electrons to the ESR absorption intensity starts to emerge. The largest contribution is made to the full width of half maximum intensity of the absorption peak by the localized electrons. By comparing the full width of half maximum intensity at a temperature of 40 K to the full width of half maximum intensity of the absorption peak around room temperature at which little effect of the localized electrons emerges, the magnitude of the effect of the localized electrons on the conduction electrons can be understood.

Specifically, the relative ratio (ΔH_{40K}/ΔH_{296K}) of the full width of half maximum intensity ΔH_{40K}of the absorption peak measured at a temperature of 40 K to the full width of half maximum intensity ΔH_{296K} of the absorption peak measured at a temperature of 296 K is very useful as a method of understanding the magnitude of the contribution of the localized electrons in relation to the conduction electrons.

The results of the floating charge test at 60° C. are shown in foregoing Table 2. FIG. 6 shows a relationship between the relative ratio (ΔH_{40K}/ΔH_{296K}) of the positive electrode graphite powder and the ratio of residual capacity after the high temperature floating charge. Table 2 shows that the capacities of 20th cycle of any cell were similar to each other, and there was no difference between them.

FIG. 6 shows the relationship between the relative ratio (ΔH_{40K}/ΔH_{296K}) and the ratio of residual capacity.

The relative ratio (ΔH_{40K}/ΔH_{296K}) of graphite F is the smallest among all samples. The ratio of the number of the localized electrons to the number of conduction electrons is estimated to be large. It is, therefore, presumed that the oxidation composition reaction of the liquid electrolyte was promoted on the surface of the positive electrode graphite powder, generating gas.

The graphite B and the graphite D were synthesized by heat-treating the graphite A, which was a reference, in a hydrogen atmosphere or reduced pressure atmosphere, respectively. They had such a higher relative ratio (ΔH_{40K}/ΔH_{296K}) than that of the graphite A as to have an improved capacity maintaining rate after performing the float charge. The graphite B which was heat-treated in a hydrogen atmosphere particularly had the highest relative ratio (ΔH_{40K}/ΔH_{296K}) and the highest capacity maintaining rate.

In contrast, the graphite C and the graphite E which were synthesized by heat-treating the graphite A in a nitrogen or argon atmosphere, respectively, had a smaller relative ratio (ΔH_{40K}/ΔH_{296K}) than that of the graphite A and a smaller capacity maintaining rate.

As described above, the ratio of residual capacity after performing the floating charge test depends strongly on the above relative ratio (ΔH_{40K}/ΔH_{296K}) of the positive electrode graphite powder. If the ratio was 2.1 or more, the ratio of residual capacity after performing the floating charge at 60° C. was 87.5% or more, which was higher than that of the graphite A.

7-2. Example of Second Synthesis Method

FIG. 6 shows the relationship between the relative ratio (ΔH_{40K}/ΔH_{296K}) and the ratio of residual capacity.

The graphite H is synthesized by oxidizing the graphite G by air to introduce a functional group containing oxygen therein and by heat-treating the same in a hydrogen atmosphere. The oxidation and the hydrogen heat treatment caused the relative ratio (ΔH_{40K}/ΔH_{296K}) to be increased from 2.0 to 3.6. It is presumed that this is because the oxidation and the heat treatment decreased the number ratio of the localized electrons to the conduction electrons. The capacity maintaining rate of battery G was 78.5%, while that of battery H was 96.2%. This shows that the ratio of residual capacity was largely improved.

The graphite I had a relative ratio (ΔH_{40K}/ΔH_{296K}) of 2.1, although it was not oxidized and not heat-treated. A battery I achieved a capacity maintaining rate of 87.5%. This shows that the graphite I and the battery I have a higher relative ratio (ΔH_{40K}/ΔH_{296K}) than those of the graphite powders G, M, and K which are not oxidized and not heat-treated, as well as a higher capacity maintaining rate than those of the batteries G, M, and K, respectively. As seen from the above description, to obtain the graphite powder according to the present invention, the oxidation and heat treatment are not necessarily required. If the relative ratio (ΔH_{40K}/ΔH_{296K}) is within the scope of the present invention, a battery capacity maintaining rate of 87% or more can be achieved. The graphite J is synthesized by oxidizing the graphite I by air to introduce a functional group containing oxygen and by heat-treating the same in a nitrogen atmosphere. The graphite J had a higher relative ratio (ΔH_{40K}/ΔH_{296K}) than that of the graphite I. Furthermore, a battery J had an improved capacity maintaining rate as compared to the battery I.

The graphite L is synthesized by oxidizing the graphite K by air to introduce a functional group containing oxygen and by heat-treating the same at a reduced pressure of 10 torr or less. The graphite L had a higher relative ratio (ΔH_{40K}/ΔH_{296K}) than that of the graphite K. A battery L had an improved capacity maintaining rate as compared to a battery K. The graphite N is synthesized by heat-treating the graphite M together with KOH to introduce a functional group containing oxygen and by heat-treating the same in a nitrogen atmosphere. Any of these had an improved relative ratio (ΔH_{40K}/ΔH_{296K}) by performing the oxidation and heat treatment. It was seen to have an improved capacity maintaining rate in a case where it was used as the positive electrode material of a battery.

As described above, by performing the second synthesis method, that is, by oxidizing and heat-treating graphite powder, the relative ratio (ΔH_{40K}/ΔH_{296K}) was improved. By using the graphite powder in a positive electrode, it was possible to improve the ratio of residual capacity of a battery. The graphite powders G, K, and M which are not oxidized and not heat-treated have a relative ratio (ΔH_{40K}/ΔH_{296K}) of 2.0 or less, which departs from the scope of the present invention. When they are used in the positive electrode of a battery, the battery has a capacity maintaining rate of 80% or less. Thus, they are not preferable.

In contrast, the graphite H, J, L, and N were oxidized and heat-treated to have a relative ratio (ΔH_{40K}/ΔH_{296K}), which are within the scope of the present invention, that is, which had relative ratios (ΔH_{40K}/ΔH_{296K}) of 2.1 or more. The batteries using the graphite H, J, L, and N in the positive electrodes have a capacity maintaining rate of 90% or more. This shows that the ratio of residual capacity after performing the floating charge is improved. A battery, using graphite I which had a relative ratio (ΔH_{40K}/ΔH_{296K}) of 2.1 without applying the second synthesis method, also had a capacity maintaining rate of 87.5% after performing the floating charge. It had an improved capacity maintaining rate as compared to graphite G, M, and K.

It was seen that, as described above, by using the graphite powder having a relative ratio (ΔH_{40K}/ΔH_{296K}) of 2.1 or more as the positive electrode material of a battery, the ratio of residual capacity of the battery after performing the floating charge can be increased to at least 87.5% or more. The present invention has been described based on the typical examples thereof, but various modes can be employed in addition to the modes described above in the present invention.

The present invention has been described above based on the typical examples thereof, but various modes can be employed in addition to the modes described above in the present invention. Non-patent Document 5: Japan Society for the Promotion of Science, 117th committee, Tanso, 25, 36 (1963) in Japanese

### INDUSTRIAL APPLICABILITY

According to the present invention, a non-aqueous electrolyte secondary battery, in which the degradation of the capacity is suppressed in charge/discharge cycles after performing a high temperature floating charge, can be provided.

1. A non-aqueous electrolyte secondary battery comprising
a positive electrode made of graphite powder and
a negative electrode made of any one of lithium metal and a lithium-intercalatable/deintercalatable material, wherein
the positive electrode and the negative electrode are faced to each other with an electrolyte, containing a lithium salt, interposed in between,
the positive electrode has a carbon-derived absorption peak which appears within a range of 3200 gauss to 3400 gauss in an electron spin resonance method in which measurement is performed using an X band, and
a relative ratio (ΔH_{40K}/ΔH_{296K}) of the full width of half maximum intensity ΔH_{40K}of the peak measured at a temperature of 40 K to the full width of half maximum intensity ΔH_{296K} Of the peak measured at a temperature of 296 K of the positive electrode is 2.1 or more.
